(19) United States
(12) Patent Application Publication
(10) Pub. No.: US 2016/0255375 A1
(43) Pub. Date: Sep. 1, 2016

(54) MULTIPOINT BROADCAST METHOD

(71) Applicant: VOGO, Montpellier (FR)

(72) Inventors: Christophe CARNIEL, Castelnau Le Lez (FR); Daniel DEDISSE, Prades Le Lez (FR); Pierre KEIFLIN, Carnon (FR)

(21) Appl. No.: 15/028,403

(22) PCT Filed: Oct. 23, 2014
(86) PCT No.: PCT/FR14/52705

§ 371 Date: Apr. 8, 2016

(30) Foreign Application Priority Data
Oct. 23, 2013 (FR) 13 60299

(51) Int. Cl. H04N 21/214; H04N 21/61; H04N 21/6405; H04N 21/6587; H04N 21/414; H04N 21/234

(52) U.S. Cl. CPC H04N 21/2143; H04N 21/41407; H04N 21/23406; H04N 21/6405; H04N 21/6587; H04N 21/6131

(57) ABSTRACT

The method for distributing video streams performs a simultaneous and continuous capture of different video sequences, which are converted as they are captured into streams of digital video data continuously transmitted in multipoint distribution from one transmitter to at least two remote mobile terminals personal to a user, via a telecommunication network. At the level of each terminal, the streams are received and an interface for controlling their distribution is displayed. The interface permits each user to select one video sequence for viewing at the level of his terminal as well as to control the distribution of viewing by streaming at actual speed, or by changing the frame rate, and/or by choosing the direction of streaming, and/or by selecting a moment of the sequence.

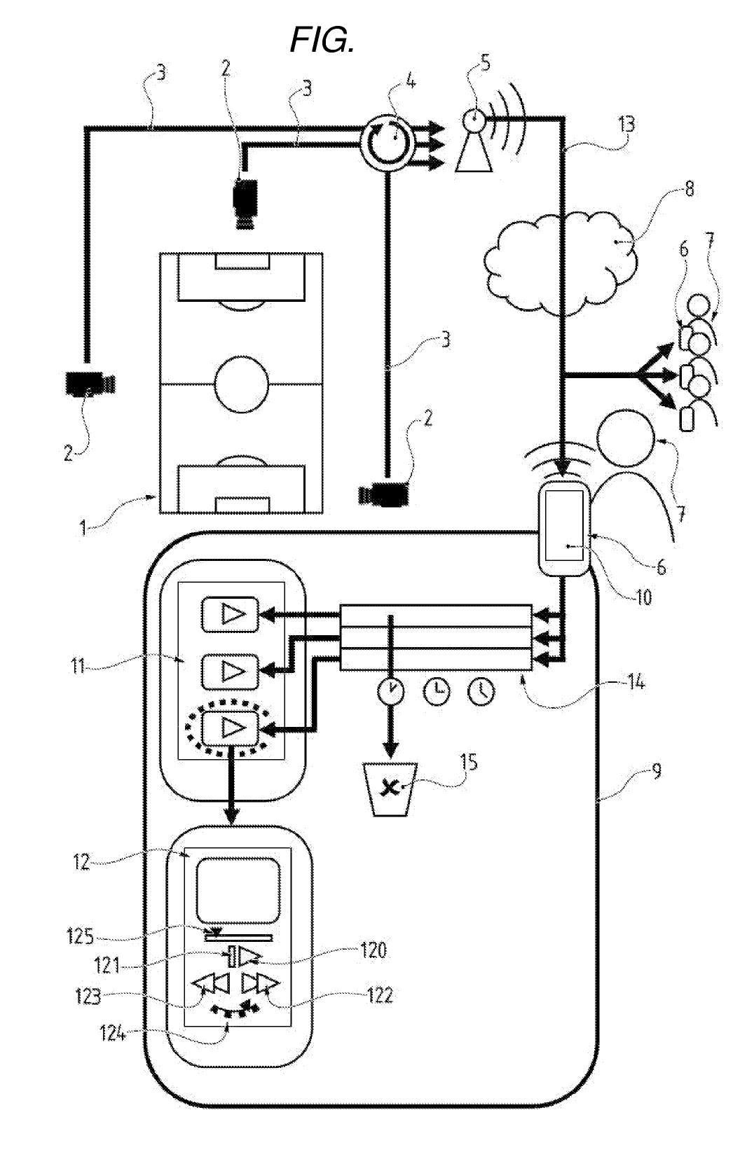

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention is related to the field of the communications and the transmission of digital data.

The invention relates in particular to a method for distributing digital data, at least such as video data, preferably audio and video data.

Such a method will find a particular application, but in no way limited to, the capture, transmission and distribution to the spectators of video data during events, namely sports or music events, locally on spot within a sports or cultural arena, at the place where said events are held. The invention is also likely to find an application during events such as conventions, during a presentation, a lecture, a speech or any oratory scene.

2. Description of Related Art Including Information Disclosed Under 37 CFR 1.97 and 37 CFR 1.98

In a known way, during an event, for example a sports event taking place in a stadium, the distribution of the video sequences captured in real time occurs through one or more giant screens said place is provided with, even through monitors present at different locations of the said place, as in the boxes. Such screens permit the simultaneous as well as the deferred transmission of one sequence at a time, the selection and displaying on this screen of the sequence being controlled by an operator in a control room dedicated to the video.

Such a system requires the setting up of a dedicated infrastructure, inside the place, expensive and complex to be managed, which does not give the spectator the option as to the sequences that are distributed.

An existing solution for transmitting a data stream is described in US 2003/058866. This solution consists of a remote data transmission system, for conventionally transmitting data via a network between two terminals.

Such a solution is not aimed at optimizing such a transfer in a particular localized arena, in the meaning of the present invention, as this is the case during sports or music events.

This technology does not take into consideration the rights related to the contents being transmitted, by limiting their storage time on the terminal.

### BRIEF SUMMARY OF THE INVENTION

The aim of the present invention is to cope with the drawbacks of the prior art by providing the simultaneous distribution of several different video sequences directly to the spectators, i.e. the spectators at the level of their personal terminal, preferably their cell phone or their tablet. To this end, the invention uses an existing wireless 15 telecommunication network, namely a radio distribution network, in particular the mobile phone network. Thus, the invention permits to simplify the infrastructure to be installed in the place where the event is held.

In addition, the invention provides a software application, which each user terminal is provided with, permitting the latter to manage the distribution of one and/or the other of said sequences. Each user can then choose to review a specific moment of the event already passed, according to different viewing angles.

Moreover, such an application permits to control the distribution of each sequence in order to permit the user to namely perform a slow-motion of said moment, or other actions on the sequence he has selected.

To this end, the present invention relates to a method for distributing digital data streams, at least such as video data, wherein:
a simultaneous and continuous capture of at least two separate video sequences is performed and they are converted as they are captured into at least two streams (3) of digital data, at least such as video data;
said digital streams (3) are continuously transmitted in multipoint distribution from at least one transmission terminal (5) to at least two mobile terminals (6), located at a distance, each terminal (6) being personal to a user (7), via a telecommunication network (8);

at the level of each terminal (6), said streams (3) are received and an interface (9) for controlling their distribution is displayed.

Such a method is characterized in that:
said interface (9) permits each user (7) to select one and/or the other of said video sequences for its viewing at the level of his terminal (6) as well as to control the distribution of said viewing by streaming at actual speed, or by stopping, slowing down, accelerating the frame rate, and/or by choosing the direction of streaming, and/or by selecting a moment of said sequence and in that it consists in:
temporarily storing each stream (3) in a buffer (14) of the circular type, at the level of the internal memory of each terminal (6); and
continuously deleting in time each stream (3) stored in said buffer (14) after a time interval determined with respect to a duration defined for each video sequence, said time interval corresponding to a duration from several minutes to several tens of minutes.

Moreover, according to other additional non-restrictive features, such a method may consist in continuously deleting in time each stream stored in said buffer after a time interval determined with respect to a duration defined for each video sequence.

In addition, said time interval may correspond to a duration from 10 to 20 minutes.

Thus, the invention technically permits to manage the rights related to the distribution of the data captured during the event, ensuring their deletion.

### BRIEF DESCRIPTION OF THE SEVERAL VIEWS OF THE DRAWINGS

Further features and advantages of the invention will become clear from the following detailed description of non-restrictive embodiments of the invention, with reference to the attached FIGURE, a schematic view showing a principle example of the architecture of a mode of operation of the diffusion method according to the invention.

### DETAILED DESCRIPTION OF THE INVENTION

The present invention relates to the distribution of digital data.

Such a distribution is performed within the framework of events, in particular sports events. Preferably, this distribution can occur within a sports arena or around a field 1 for receiving the spectators who have come and watch and/or participate in this event.

Such digital data can be at least video data. These video data can also be coupled with sound data such as audio and/or image data, namely still images.

Said video data result from a capture consisting of an acquisition of video sequences. Such an acquisition can be performed by adapted video capture means, namely cameras 2, even, for the photos, adapted devices.

In the example shown, several cameras 2 arranged at different locations in the sports arena, namely around the field 1, each perform an acquisition of a particular sequence at a specific angle. All these acquisitions then form said capture that pretends to be simultaneous and continuous.

According to the example, three different video sequences are acquired, but the invention provides for performing a simultaneous and continuous capture from at least two different video sequences, namely from two different cameras 2 and therefore from two different viewing angles. A larger number of video captures can be performed, depending on the means used for this purpose, namely the number of cameras 2.

Moreover, the sequences are converted as they are captured into at least two streams 3 of digital data, at least such as video data. A possible conversion 4 can consist of a step of compressing the data, in order to optimize their transmission via a network. This compression can occur in real time through a system such as an audio/video encoder, so as to convert each stream 3 into an encoded stream.

Other conversions 4 are possible, which consist in processing said data, namely the insertion of self-correction codes in order to cope with the transmission errors via wireless networks. Such a processing can be performed in part directly at the levels of the cameras 2 or in part at the level of a remote centralized location, such as for example in a control room.

Then, the invention provides for continuously transmitting said digital streams 3 from at least one transmission terminal 5 to at least two mobile terminals 6 located at a distance, each terminal being personal to a user 7. The latter is preferably a spectator who has come and attend the event, located in the sports arena where said event takes place, namely in the stadium 1 or near the field, namely in the stands or the boxes.

In addition, this transmission step is performed via a telecommunications network 8. In the meaning of the present invention, said network 8 is a wireless radio network.

Preferably, such a network may be dedicated to mobile telephony. Therefore, said terminal 6 is formed of a receiver capable of being connected to such a telephony network 8, preferably a cell phone such as a “smartphone” (for “intelligent phone”), or to a tablet.

According to an alternative embodiment, depending on the place where the event is held, another type of network can be used, namely wireless LAN, such as “Wifi” or “WiMAX”.

In particular, the invention provides for transmitting said streams 3 by means of a transmission technology of the “multipoint” type, or “multipoint” or “group” transmission. This kind of distribution uses a single transmitter, in the form of said transmission terminal, sending at least one signal 13 to several receivers, i.e. the terminals 6. In fact, this is a “point to multipoint” communication. In particular, each stream 3 can be converted into a signal 13 that is specific to it. Then there are as many signals 13 as there are streams 3.

Preferably, the invention uses a technology such as “Multimedia Broadcast Multicast Services” (MBMS) of the fourth generation mobile telephony networks (4G/LTE for “Long Term Evolution”).

After sending the streams 3, these are received at the level of said terminal 6 and an interface 9 for controlling their distribution is displayed.

Such an interface 9 may consist of a software application incorporated into said terminal 6 and dedicated. In particular, said application can be previously installed and performed from the memory of the terminal 6.

In particular, the performing of said application can start a client request within the above-mentioned multicast communication system. A step of identifying and/or authenticating the user 7 may be required, e.g. within the framework of a subscription to a service, in particular a paid service, in order to obtain the receiving of said streams 3 and the viewing of said sequences.

Moreover, said application permits, on the one hand, to manage the receiving of the streams 3, namely in order to convert them for distributing the sequences they correspond to. Then the display means of the terminal 6, i.e. its screen 10, permits to view said sequences after conversion of the streams 3.

A simple conversion consists only in reading directly the encoded stream. In fact, part of the software application is capable of transcribing and reading the encoded stream, without any other additional processing, preferably continuously as it is received.

A possible conversion can consist of a decoding of the stream, namely in real time.

Another type of conversion can consist in correcting the data packets of the streams 3, namely in case of absence of or error in some packets.

On the other hand, the application permits the user 7 to choose the playback mode for one or several video sequences corresponding to said streams 3 being received. To this end, said screen 10 may be designed as a touch screen, while the interface 9 has selectable elements, such as icons or buttons, forming the means for controlling the distribution of one or several sequences.

As such, the invention is characterized in that said interface 9 permits said user 7 to select one and/or the other of said video sequences for its viewing at the level of said terminal 6. To this end, said interface 9 includes a first menu 11 for selecting the sequence the user 7 wants to view. In the example shown, this is the last sequence that was selected for its viewing on the screen 10 of the terminal 6.

In addition, the interface 9 also permits to control the distribution of said viewing by scrolling at actual speed, or by stopping, slowing down, accelerating the frame rate, and/or by choosing the direction of scrolling, and/or choosing a moment of said sequence. In other words, a second menu 12 permits to control all the aspects of reading of the previously selected sequence.

In a non-restrictive way, it is possible for the user, through an icon or a play button 120, to start playing the video sequence. Another icon or stop button 121 permits to stop the playback, making a freeze frame or pause at a specific moment. Another icon or button 122 permits to scroll forward, while yet another one 123 permits to scroll backward. It is then also possible to perform temporally an increasing, but also decreasing playback in time, by changing the direction of scrolling. An additional icon or button 124 can also permit to manage the frame rate, by accelerating or decelerating it, in order to obtain a slow-motion that can reach an image-wise playback of the sequence. Finally, another icon or button 125, namely in the form of a scroll bar, permits to select a specific moment of the video sequence, then to apply one and/or the other of the previous controls.

Thus, the user can see at will a specific moment of the event he is attending, by fully controlling the distribution and watching according to several viewing angles corresponding to each sequence. In the example of a sports event, such as a sports meeting between two teams, the user can then see and view again an action in all its details.

According to a particular embodiment, not shown, the interface 9 permits to control the distribution of the simultaneous viewing of two sequences. In fact, a second menu can be doubled in order to separately manage the control of the playback of each sequence, which is displayed simultaneously on said screen 10. This peculiarity permits the user to compare at the same time several viewing angles.

It is therefore possible to synchronize the two sequences so that their playing back occurs from a same moment.

To this end, the invention consists in temporarily storing each stream 3 in a buffer 14 of the circular type, at the level of the internal memory of said terminal 6. Such a buffer 14 is similar to a circular or rotary “buffer” the memory space of which is limited to a predefined size. In case of saturation of this memory space, the new data “replace” the oldest data, namely by crushing the corresponding memory space.

In other words, the invention consists in deleting continuously in time each stream 3 stored in said buffer 14 after a time interval determined with respect to a duration defined for each video sequence. Such duration may namely correspond to a size of each sequence, depending on the video format of its stream 3.

In particular, according to the preferred embodiment, said time interval may correspond to a duration from several minutes to several tens of minutes, namely from 10 to 20 minutes.

Furthermore, the invention provides for limiting the storage time of the digital data being transmitted and read at the level of each terminal 6. This peculiarity permits to eliminate the problems related to the management of the distribution rights by providing a technical solution that progressively deletes the data received by each terminal 6, i.e. the video sequences.

Therefore, the replacement of old data of each stream 3 by the arrival of new data of that same stream 3 in said buffer 14 simulates a delete operation 15, as shown schematically. Moreover, it is possible to consider, at the end of the event the user 7 is attending, to continue the transmission of the streams 3, without content, for a given and sufficient period of time, in order to continue the crushing and this deletion of all previous data, until the memory is empty of all content.

In addition, it is also possible to remotely control, through a specific signal incorporated in one of said streams 3, the stopping of said software application and its closing, in order to fully empty the buffer 14, thus ensuring the destruction of the data it contains.

According to a simplified embodiment, after a period of time, upon closing said application, the voluntary or forced disconnection of the user 7, the buffer is emptied of any data it contains.

In view of the above, the invention permits to significantly reduce the amount of data transmitted on said network 8, limiting the risk of saturation of passband. In addition, since the management by the user 7 is performed locally at the level of the terminal 6, no other communication tool or protocol is required, thus avoiding a remote execution on a dedicated server.

Thus, the method according to the present invention permits a spectator to indeed see again a past moment of an event he is attending, according to the viewing angle he desires.

1. A method for distributing digital data streams to spectators during events onsite, said spectators also being onsite, the method comprising the steps of:
performing a simultaneous and continuous capture of at least two separate video sequences, each separate video sequence being converted while being captured into a respective digital stream of digital data;
continuously transmitting the digital streams in multipoint distribution from at least one transmission terminal to at least two mobile terminals, located at a distance, each termina being personal to a user, via a telecommunication network; and
receiving the digital streams at the level of each terminal and displaying an interface for controlling distribution;
wherein each interface for a respective user permits selection of video sequences for viewing at the level of a respective terminal and controls distribution of said viewing by streaming at actual speed, or by stopping, slowing down, accelerating the frame rate, and/or by choosing the direction of streaming, and/or by selecting a moment of said sequence;
wherein each stream is temporarily stored in a buffer of a circular type, at a level of internal memory of each terminal; and
wherein each stream stored in said buffer after a time interval determined with respect to a duration defined for each video sequence is continuously deleted, said time interval corresponding to a duration from several minutes to several tens of minutes.

2. The distribution method according to claim 1, wherein said time interval corresponds to a duration from 10 to 20 minutes.
